(19) United States
(12) Patent Application Publication
(10) Pub. No.: US 2007/0197684 A1
(43) Pub. Date: Aug. 23, 2007

(54) Ink-jet ink sets, ink cartridge, ink-jet recording method, and ink-jet recording apparatus

(75) Inventors: Yoshiro Yamashita, Kanagawa (JP); Ken Hashimoto, Kanagawa (JP)

Correspondence Address: FILDES & OUTLAND, P.C., 20916 MACK AVENUE, SUITE 2, GROSSE POINTE WOODS, MI, 48236, US

(73) Assignee: Fuji Xerox Co., Ltd.

(21) Appl. No.: 11/503,734

(22) Filed: Aug. 14, 2006

(30) Foreign Application Priority Data
Feb. 22, 2006 (JP) 2006-045294

(51) Int. Cl. C09D 11/00

(52) U.S. Cl. 523/160

(57) ABSTRACT

The present invention provides an ink-jet ink set having at least: an ink which contains at least an inorganic oxide pigment and a resin; and a second liquid which contains at least a coagulant capable of coagulating the inorganic oxide pigment. The ink-jet ink set is preferably used for recording of a white image. The present invention further provides an ink cartridge which contains the ink-jet ink set. The present invention further provides an ink-jet recording method having at least forming an image by ejecting the ink from an ink-jet recording head and providing the second liquid on a recording medium. The present invention further provides an ink-jet recording apparatus having at least an ink-jet recording head which ejects the ink and a device which provides the second liquid onto the recording medium.

### BACKGROUND OF THE INVENTION

1. Field of the Invention

The present invention is concerned with ink-jet ink sets, ink cartridges, ink-jet recording methods, and ink-jet recording apparatuses.

2. Description of the Related Art

A lot of printers utilize the ink-jet recording method since the method can reduce the cost with compact apparatuses. In the ink-jet recording method, ink is ejected from the ink ejection opening formed by a nozzle, a slit, and porous film, in which the ink is in a form of liquid or molten solid. Particularly, the piezo ink-jet method and the thermal ink-jet method are suitable in view of high-resolution, high-speed printing and the like. The piezo ink-jet method utilizes deformation of a piezoelectric element for ejecting ink. The thermal ink-jet method utilizes boiling of ink upon application of thermal energy, for ejecting ink. The ink jet recording method can be applicable to printing on films such as OHP sheet, cloth or the like as well as on papers such as plain paper, ink-jet purpose paper or the like.

On the other hand, it is desired that white ink that is used to obtain a white image or to mask an image already formed on a recording medium is high in print density and excellent in masking property. As a colorant thereof, an inorganic oxide pigment and, in particular, titanium dioxide, is preferably used. However, there is a disadvantage in that the inorganic oxide pigment, having a large specific gravity, tends to sediment more readily than carbon black or an organic pigment and clog an ink-jet head. Furthermore, it is desired that the white ink is excellent in fixing property and storage stability.

### SUMMARY OF THE INVENTION

The invention provides an ink-jet ink set that does not generate clogging at an ink-jet head, is high in print density, excellent in fixing property and storage stability and excellent in masking property of a lower image when an image is formed over another formed image; an ink cartridge that houses the ink-jet ink set; an ink-jet recording method that uses the ink-jet ink set; and an ink-jet recording unit.

The present invention has been made in consideration of the above problems.

Namely, the present invention provides an ink-jet ink set comprising: an ink that comprises an inorganic oxide pigment and a resin; and a second liquid that comprises a coagulant capable of coagulating the inorganic oxide pigment.

### BRIEF DESCRIPTION OF THE DRAWINGS

FIG. 1 is a perspective view illustrating the external constitution of a preferable embodiment of the ink-jet recording apparatus of the invention.

FIG. 2 is a perspective view illustrating the basic interior constitution of the ink-jet recording apparatus of FIG. 1.

FIG. 3 is a perspective view illustrating the external constitution of another preferable embodiment of the ink-jet recording apparatus of the invention.

FIG. 4 is a perspective view illustrating the basic internal constitution of the ink-jet recording apparatus of FIG. 3.

### DESCRIPTION OF THE PRESENT INVENTION

### Ink Set for Ink-Jet Recording

The ink-jet ink set of the present invention (hereinafter sometimes referred as the “ink set of the invention”) have the characteristics of having at least an ink that has at least an inorganic oxide pigment and a resin; and a second liquid that has at least a coagulant capable of coagulating the inorganic oxide pigment.

Components of the ink-jet ink set of the present invention are explained below.

### Inorganic Oxide Pigment

Ink in the ink-set according to the invention includes an inorganic oxide pigment as a colorant. The ink-set according to the invention, when, as the colorant, the inorganic oxide pigment is used together with a resin described below, becomes an ink-set high in print density and excellent in masking property of a lower image when an image is formed over another formed image, fixing property and storage stability. Examples of the inorganic oxide pigment include, titanium dioxide, zinc oxide, tin oxide, zirconium oxide and antimony oxide, preferably titanium dioxide and zinc oxide, and more preferably titanium dioxide.

Furthermore, the inorganic oxide pigment, in order to improve the dispersibility by means of a resin, may be surface-treated with silica/alumina.

In addition, the inorganic oxide pigment that is used in the invention preferably has a number average dispersion particle diameter in the range of about 10 to 100 nm, more preferably in the range of about 20 to 90 nm and still more preferably in the range of about 30 to 80 nm. When the number average dispersion particle diameter of the inorganic oxide pigment that is used in the invention is in the range of about 10 to 100 nm, the masking property after flocculation and the storage stability can be further improved without causing clogging at an ink-jet head. Generally, when the number average dispersion particle diameter of the inorganic oxide pigment is made smaller, although the masking property after flocculation and the storage stability can be improved, sedimentation occurs more severely resulting in clogging of an ink-jet head. However, in the invention, when a resin is used together with an inorganic oxide pigment, the sedimentation of the inorganic oxide pigment can be suppressed, resulting in suppression of clogging at the ink-jet head.

The number average dispersion particle diameter of an inorganic oxide pigment that is used in the invention can be measured by the following laser diffraction/scattering method.

In the laser diffraction/scattering method, a laser beam is irradiated on particles, generated scattered light is gathered with a lens, and, from the brightness and magnitude of an obtained diffraction image, particle diameters and the distribution thereof are determined.

### Resin

The ink in the ink-set according to the invention contains a resin as a dispersing agent. Since the ink in the ink set of the invention contains the resin, the fixing property and the dispersing property can be improved, and thereby, the sedimentation of the inorganic oxide pigment can be suppressed even when the number average dispersion particle diameter thereof is made smaller. The “resin” used in the invention designates a polymer that has a number average molecular weight in the range of about 1,000 to 500,000.

Furthermore, the resin that is used in the invention is preferably a resin having, as a solublizing group, a weak acidic functional group or a weak basic functional group, and more preferably, a resin having a weak acidic functional group.

Here, the “weak acidic functional group” means a functional group that is an acidic group that generates H⁺ while the degree of ionization is less than 1. Specific examples of the weak acidic functional group include a carboxylic group, an organic phosphoric acid group and a phenolic OH group, and a carboxylic functional group is preferable.

On the other hand, the “weak basic functional group” means a functional group that is a basic group that generates OH⁻ while the degree of ionization is less than 1. Specific examples of the weak basic functional group include an amino group and an imino group.

Examples of the resin that can be used in the invention include an anionic compound, a cationic compound and an amphoteric compound. Examples of the anionic compound used as the resin include a copolymer that is obtained by copolymerizing a single monomer or a plurality of monomers having an α,β-ethylenic unsaturated group. Specific examples of the copolymer include a styrene-maleic acid copolymer, a styrene-methacrylic acid copolymer, a styrene-acrylic acid copolymer, a styrene-acrylic acid-acrylic acid ester copolymer, a vinylnaphthalene-maleic acid copolymer, a vinylnaphthalene-methacrylic acid copolymer, a vinylnaphthalene-acrylic acid copolymer, an acrylic acid alkyl ester-acrylic acid copolymer, a methacrylic acid alkyl ester-methacrylic acid copolymer, a styrene-methacrylic acid alkyl ester-methacrylic acid copolymer, a styrene-acrylic acid alkyl ester-acrylic acid copolymer, a styrene-methacrylic acid phenyl ester-methacrylic acid copolymer, a styrene-methacrylic acid cyclohexyl ester-methacrylic acid copolymer and a methacrylic acid-methacrylic acid ester copolymer.

Examples of the cationic compound used as the polymer dispersing agent include copolymers such as N,N-dimethylaminoethyl methacrylate, N,N-dimethylaminoethyl acrylate, N,N-dimethylaminomethacrylamide or N,N-dimethylaminoacrylamide.

Examples of the amphoteric compound used as the polymer dispersing agent include a betaine type compound.

Among the above, preferable examples of a resin that is used as the polymer dispersing agent in the invention include a methacrylic acid-methacrylic acid ester copolymer, a styrene-alkyl methacrylate-methacrylic acid copolymer and a styrene-cyclohexyl methacrylate-methacrylic acid copolymer.

A ratio of the amount of the resin to the amount of the inorganic oxide pigment (inorganic oxide pigment:resin, by mass ratio) is preferably in a range of approximately 1:0.3 to 1:0.01, more preferably in a range of approximately 1:0.28 to 1:0.02, and still more preferably in a range of approximately 1:0.25 to 1:0.03. When the ratio of the amount of the resin to that of the inorganic oxide pigment is larger than about 1:0.3, in some cases, the viscosity of the ink becomes too high or, owing to a strong interaction between the resins, flocculation tends to occur. On the other hand, when the ratio is less than about 1:0.01, the inorganic oxide pigment cannot be sufficiently dispersed, resulting, in some cases, in sedimentation of the pigment.

### Flocculating Agent

A substance (hereinafter, in some cases, referred to as a “coagulant of the invention”) that coagulates the inorganic oxide pigment that is used in the invention means a substance that reacts or interacts with the inorganic oxide pigment to cause an effect of increasing the viscosity or causing coagulation. Examples of this substance include a polyvalent metal ion or a cationic substance. Specifically, an inorganic metal salt, an organic polyamine compound, an organic acid and a salt thereof as indicated below can be effectively used, and an organic acid and a salt thereof are preferable.

Examples of the inorganic metallic salt include salts between alkaline metal ions (such as a lithium ion, a sodium ion, or a potassium ion) or multivalent metal ions (such as an aluminum ion, a barium ion, a calcium ion, a copper ion, an iron ion, a magnesium ion, a manganese ion, a nickel ion, a tin ion, a titanium ion, or a zinc ion) and acids (such as a hydrochloric acid, a hydrobromic acid, a hydroiodic acid, a sulfuric acid, a nitric acid, a phosphoric acid, a thiocyanic acid, or an organic sulfonic acids).

Specific examples of the inorganic metallic salt include:
salts of alkaline metals such as lithium chloride, sodium chloride, potassium chloride, sodium bromide, potassium bromide, sodium iodide, potassium iodide, sodium sulfate, or potassium nitrate;
salts of multivalent metals such as aluminum chloride, aluminum bromide, aluminum sulfate, aluminum nitrate, aluminum sodium sulfate, aluminum potassium sulfate, barium chloride, barium bromide, barium iodide, barium oxide, barium nitrate, barium thiocyanate, calcium chloride, calcium bromide, calcium iodide, calcium nitrite, calcium nitrate, calcium dihydrogenphosphate, calcium thiocyanate, calcium benzoate, calcium acetate, calcium salicylate, calcium tartrate, copper chloride, copper bromide, copper sulfate, copper nitrate, copper acetate, iron chloride, iron bromide, iron iodide, iron sulfate, iron nitrate, magnesium chloride, magnesium bromide, magnesium iodide, magnesium sulfate, magnesium nitrate, manganese chloride, manganese sulfate, manganese nitrate, manganese dihydrogen phosphate, nickel chloride, nickel bromide, nickel sulfate, nickel nitrate, tin sulfate, titanium chloride, zinc chloride, zinc bromide, zinc sulfate, zinc nitrate, or zinc thiocyanate; and the like.

Examples of the organic polyamine compound include a primary amine, a secondary amine, a tertiary amine, a quaternary amine, and a salt thereof.

Specific examples of the organic polyamine compound include a salt of tetraalkylammonium, a salt of alkylamine, a salt of benzalkonium, a salt of alkylpyridium, a salt of imidazolium, and a salt of polyamine. More specific examples of the organic polyamine compound include isopropylamine, isobutylamine, t-butylamine, 2-ethylhexylamine, nonylamine, dipropylamine, diethylamine, trimethylamine, triethylamine, dimethylpropylamine, ethylenediamine, propylenediamine, hexamethylenediamine, diethylenetriamine, tetraethylenepentamine, diethanolamine, diethylethanolamine, triethanolamine, tetramethylammonium chloride, tetraethylammonium bromide, dihydroxyethylstearylamine, 2-heptadecenyl-hydroxyethylimidazoline, lauryldimethylbenzylammonium chloride, cetylpyridinium chloride, stearamidemethylpyridium chloride, diallyldimethylammonium chloride polymer, diallylamine polymer, monoallylamine polymer, and onium salts thereof (such as a sulfonium salt or a phosphonium salt), and phosphoric acid esters.

Preferable examples of the organic acid and the salt of an organic salt include a carboxylic acid, a salt thereof, an organic sulfonic acid and a salt thereof, and more preferable examples of the organic acid and salts thereof include compounds represented by the following formula (1), an acetic acid, an oxalic acid, a lactic acid, a fumaric acid, a phthalic acid, a citric acid, a salicylic acid, a benzoic acid, a glucuronic acid, an ascorbic acid, and salts thereof. The salts of the organic acids may be either fully neutralized or partially neutralized.

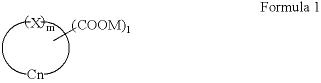

In Formula (1), X represents O, CO, NH, NR, S, or SO₂ wherein R represents an alkyl group. R preferably represents CH₂, C₂H₅, or C₂H₄OH. X preferably represents CO, NH, NR, or O, more preferably CO, NH, or O.

M represents a hydrogen atom, an alkaline metal, or an amine. M preferably represents H, Li, Na, K, monoethanolamine, diethanolamine, or triethanolamine. M more preferably represents H, Na, or K, and still more preferably represents a hydrogen atom.

n represents an integer of 3 to 7. n preferably represents such an integer that the ring is a 5- or 6-membered ring, more preferably represents such an integer that the ring is a 5-membered ring. m represents 1 or 2. The rings of the compounds represented by Formula (1) may be saturated or unsaturated as long as it is a heterocyclic ring. l represents an integer of 1 to 5.

Examples of the compound represented by Formula (1) include a compound including a carboxyl group, which is provided as a functional group of the compound, and a structure selected from the group consisting of furan, pyrrole, pyrroline, pyrrolidone, pyrone, thiophene, indole, pyridine, and quinoline. Specific examples thereof include 2-pyrrolidone-5-carboxylic acid, 4-methyl-4-pentanolide-3-carboxylic acid, furancarboxylic acid, 2-benzofuran carboxylic acid, 5-methyl-2-furan carboxylic acid, 2,5-dimethyl-3-furan carboxylic acid, 2,5-furandicarboxylic acid, 4-butanolide-3-carboxylic acid, 3-hydroxy-4-pyrone-2,6-dicarboxylic acid, 2-pyrone-6-carboxylic acid, 4-pyrone-2-carboxylic acid, 5-hydroxy-4-pyrone-5-carboxylic acid, 4-pyrone-2,6-dicarboxylic acid, 3-hydroxy-4-pyrone-2,6-dicarboxylic acid, thiophene carboxylic acid, 2-pyrrolcarboxylic acid, 2,3-dimethylpyrrol-4-carboxylic acid, 2,4,5-trimethylpyrrol-3-propionic acid, 3-hydroxy-2-indolecarboxylic acid, 2,5-dixyo-4-methyl-3-pyrroline-3-propionic acid, 2-pyrrolidinecarboxylic acid, 4-hydroxyproline, 1-methylpyrrolidine-2-carboxylic acid, 5-carboxy-1-methylpyrrolidine-2-acetic acid, 2-pyridinecarboxylic acid, 3-pyridinecarboxylic acid, 4-pyridinecarboxylic acid, pyridinedicarboxylic acid, pyridinetricarboxylic acid, pyridinepentacarboxylic acid, 1,2,5,6-tetrahydro-1-methylnicotinic acid, 2-quinolinecarboxylic acid, 4-quinolinecarboxylic acid, 2-phenyl-4-quinolinecarboxylic acid, 4-hydroxy-2-quinolinecarboxylic acid, 6-methoxy-4-quinolinecarboxylic acid, and modified compounds or salts thereof.

Preferable examples of the organic acid represented by Formula (1) include: pyrrolidonecarboxylic acid, pyronecarboxylic acid, pyrrolcarboxylic acid, furancarboxylic acid, pyridinecarboxylic acid, coumaric acid, thiophenecarboxylic acid, and nicotinic acid; and modified compounds or salts thereof. More preferable examples of the organic acid represented by Formula (1) include: pyrrolidone carboxylic acid, pyronecarboxylic acid, furancarboxylic acid, and coumaric acid; and modified compounds or salts thereof.

More preferable examples among the above include magnesium chloride, magnesium bromide, magnesium iodide, magnesium sulfate, magnesium nitrate, magnesium acetate, calcium chloride, calcium bromide, calcium nitrate, calcium dihydrogenphosphate, calcium benzoate, calcium acetate, calcium tartrate, calcium lactate, calcium fumarate, calcium citrate, a diallyldimethylammonium chloride polymer, a diallylamine polymer, a monoallylamine polymer, pyrrolidone carboxylic acid, pyrone carboxylic acid, pyrrole carboxylic acid, furan carboxylic acid, pyridine carboxylic acid, coumalic acid, thiophene carboxylic acid, nicotinic acid, potassium dihydrogencitrate, succinic acid, tartaric acid, lactic acid, potassium hydrogenphthalate, and modified compounds or salts thereof. Still more preferable examples include magnesium chloride, magnesium nitrate, calcium nitrate, a diallyamine polymer, pyrrolidone carboxylic acid, pyrone carboxylic acid, furan carboxylic acid, coumalic acid, and modified compounds or salts thereof.

The second liquid may include only one coagulant or two or more coagulants.

The content of the coagulant of the invention contained in the second liquid is preferably in a range of approximately 0.01 to 30% by mass, more preferably in a range of approximately 0.1 to 15% by mass, further preferably in a range of approximately 0.25 to 10% by mass. If the content of the coagulant of the invention in the second liquid is lower than approximately 0.01% by mass, in some cases, the coagulation of the colorant upon contact with the ink is insufficient, the optical density is low, and the feathering and intercolor bleed worsen. If the content is higher than approximately 30% by mass, in some cases, the jetting property is inferior and the liquid may not be ejected normally.

In the ink-set according to the invention, a combination of a resin having a carboxylic acid base solubilized group and an organic acid as a coagulant according to the invention is particularly preferable from the viewpoint of the masking property. Though the reason for this is not clear, it is assumed that size and distribution after coagulation are in appropriate regions.

### Water-Soluble Solvent

Any water-soluble solvent can be used in the invention as long as it is soluble to water in an amount of 0.1% by mass relative to the mass of water, and preferable examples thereof include a polyhydric alcohol, a polyhydric alcohol derivative, a nitrogen-containing solvent, an alcohol, or a sulfur-containing solvent.

Specific examples of the water-soluble solvent include:
polyhydric alcohols such as ethylene glycol, diethylene glycol, propylene glycol, butylene glycol, triethylene glycol, 1,5-pentanediol, 1,2,6-hexanetriol, glycerine, 1,2-hexanediol, 1,6-hexanediol, tetraethylene glycol, trimethylol propane, neopentyl glycol or the like;
modified compounds of polyhydric alcohol such as ethylene glycol monomethyl ether, ethylene glycol monoethyl ether, ethylene glycol monobutyl ether, diethylene glycol monomethyl ether, diethylene glycol monoethyl ether, diethylene glycol monobutyl ether, propylene glycol monobutyl ether, dipropylene glycol monobutyl ether, diethylene glycol monopropyl ether, diethylene glycol monohexyl ether, propylene glycol monomethyl ether, propylene glycol monoethyl ether, propylene glycol monopropyl ether, dipropylene glycol monomethyl ether, dipropylene glycol monoethyl ether, dipropylene glycol monopropyl ether, ethylene oxide adducts of glycerine or ethylene oxide adducts of diglycerine;
nitrogen-containing solvent such as pyrrolidone, N-methyl-2-pyrrolidone, cyclohexylpyrrolidone, or triethanolamine;
alcohols such as ethanol, isopropyl alcohol, butyl alcohol, or benzyl alcohol;
sulfur-containing solvents such as thiodiethanol, thiodiglycerol, sulfolane, or dimethylsulfoxide; and
propylene carbonate, ethylene carbonate and the like.

The ink set of the invention may comprise only one water-soluble solvent or two or more water-soluble solvents. The content of the water-soluble solvent in each of the ink and the second liquid is in a range of approximately 1% by mass to 60% by mass, and preferably in a range of approximately 5% by mass to 40% by mass. If the content is lower than approximately 1% by mass, the optical density is insufficient in some cases. If the content is higher than approximately 60% by mass, in some cases, the viscosity of the liquid is high and the jetting property of the liquid is unstable.

### Surfactant

Each of the liquids in the ink set of the invention may include a surfactant. A compound including a hydrophilic moiety and hydrophobic moiety in its molecule can be effectively used as the surfactant in the invention. The surfactant may be an anionic surfactant, a cationic surfactant, an amphoteric surfactant or a nonionic surfactant.

The anionic surfactant may be, for example, an alkylbenzene sulfonate, an alkylphenylsulfonate, an alkylnaphthalenesulfonate, a higher aliphatic acid salt, a sulfuric acid ester salt of a higher aliphatic acid ester, a sulfonic acid salt of a higher aliphatic acid ester, a sulfuric acid ester salt of higher alcohol ester, a sulfonic acid salt of higher alcohol ester, a salt of a higher alkyl sulfosuccinate, a salt of a higher alkyl phosphoric acid ester, or a salt of a phosphoric acid ester of a higher alcohol ethylene oxide adduct. Specific examples thereof include dodecylbenzenesulfonate, kerylbenzenesulfonate, isopropylnaphthalenesulfonate, monobutylphenylphenolmonosulfonate, monobutylbiphenylsulfonate, and dibutylphenylphenoldisulfonate.

Examples of the nonionic surfactant include a polypropyleneglycol ethyleneoxide adduct, a polyoxyethylene nonylphenyl ether, a polyoxyethylene octylphenyl ether, a polyoxyethylene dodecylphenyl ether, a polyoxyethylene alkyl ether, a polyoxyethylene aliphatic acid ester, a sorbitan aliphatic acid ester, a polyoxyehylene sorbitan aliphatic acid ester, an aliphatic acid alkylolamide, acetyleneglycol, an oxyethylene adduct of acetylene glycol, an aliphatic alkanolamide, a glycerin ester, and a sorbitan ester.

Examples of the cationic surfactant include a salt of a tetraalkylammonium, a salt of an alkylamine, a salt of a benzarconium, a salt of an alkylpyridinium, and a salt of an imidazolium. Specific examples thereof include dihydroxyethylstearylamine, 2-heptadecenyl-hydroxyethylimidazolin, lauryldimethylbenzylammonium chloride, cetylpyridinium chloride, and stearamidemethylpyridium chloride. Other than the above examples, the surfactant may be a biosurfactant such as spiculosporic acid, rhamnolipid, or lysolecithin.

The amount of the surfactant added to each of the ink or the second liquid is preferably lower than approximately 10% by mass relative to the total amount of the ink or the second liquid, more preferably in a range of approximately 0.01 to 5% by mass relative to the total amount of the ink or the second liquid, still more preferably in a range of approximately 0.01 to 3% by mass relative to the total amount of the ink or the second liquid. If the amount is approximately 10% by mass or higher, in some cases, the optical density may become insufficient and the storage stability of the pigment ink may deteriorate.

### Other Additives

Each of the first and second liquids in the ink set of the invention may include other additives which control the characteristics such as ejection property. Such additives may be selected from, for example, polyethyleneimine, polyamines, polyvinylpyrrolidone, polyethyleneglycol, modified compounds of cellulose such as ethylcellulose, carboxymethyl cellulose or the like, polysaccharides and modified compounds thereof, water-soluble polymers, polymer emulsions such as acrylic polymer emulsions or polyurethane emulsions, cyclodextrin, macrocyclic amines, dendrimers, crown ethers, urea and modified compounds thereof, acetamide, silicone surfactants, and fluorine-containing surfactants.

Each of the first and second liquids in the ink set of the invention may further include other additives such as pH stabilizers, antioxidants, fungicides, viscosity adjusting agents, conductive agents, UV absorbers, chelating agents and the like.

In view of obtaining both of ejectability from an ink jet head and prevention of precipitation of the inorganic oxide pigment, the viscosity of the ink is preferably in a range of approximately 3 mPa·s to 20 mPa·s, and is more preferably in a range of approximately 5 mPa·s to 15 mPa·s. The surface tension of the second liquid is preferably in a range of approximately 1 mPa·s to 20 mPa·s, and is more preferably in a range of approximately 1 mPa·s to 15 mPa·s.

In view of the drying property and prevention of non-uniformity in formed images, the surface tension of each of the ink and the second liquid is preferably in a range of approximately 20 to 40 mN/m.

In general, in the case of an ink-set being used to print on a permeable recording medium, when a reaction between ink and a second liquid is slow, there is a disadvantage in that an unreacted small particle inorganic oxide pigment permeates into the recording medium and thereby the whiteness degree thereof is likely to be deteriorated. However, since the ink-set according to the invention is highly reactive, the whiteness degree thereof is not deteriorated.

Furthermore, since a resin is contained in the ink of the ink-set according to the invention, the fixing property of the pigment is improved as well.

### Ink Cartridge

The ink cartridge according to the invention houses the ink-set according to the invention in a container, and further includes other members appropriately selected as necessary.

The container is not particularly limited. The shape, structure, size and material of the container can be appropriately selected in accordance with the use thereof. Preferable examples thereof include one that at least has an ink bag made of an aluminum-laminated film or a resinous film.

Further examples thereof include an ink tank described in JP-A No. 2001-138541. In this case, since each of the ink and second liquid in the ink-set according to the invention is filled in an ink tank, when ink is discharged (ejected) from an ink-jet head, deterioration in the ink characteristics during long-term storage in the ink tank can be prevented, and, in particular, the discharging property from a recording head during long-term storage can be sufficiently satisfied.

### Ink-Jet Recording Method and Ink-Jet Recording Apparatus

The ink-jet recording method of the invention uses the ink-jet ink set of the invention described above, and at least includes forming an image by ejecting the above-described inks from an ink jet head onto a recording medium. The ink-jet recording method preferably comprises forming an image by ejecting the ink and the second liquid from the ink jet head so as to contact with each other on the recording medium.

The ink-jet recording apparatus of the invention uses the ink set of the invention and comprises an ink-jet head which ejects the ink to a recording medium. The ink-jet recording apparatus of the invention preferably comprises ink-jet heads, each of which ejects the ink or the second liquid to the recording medium. The ink-jet recording apparatus may be a plain ink-jet recording apparatus or a recording apparatus having a heater which controls drying of the inks or a recording apparatus which is equipped with a intermediate member transfer system and which conduct printing the recording material on the intermediate member followed by transfer of the printed recording material to a recording medium such as paper.

From the viewpoint of suppression of feathering and intercolor bleed, the ink-jet recording method and apparatus of the invention preferably utilizes the thermal ink-jet recording method or the piezo ink-jet recording method. The reason is supposedly as follows. In the thermal ink-jet recording method, the ink is heated and has a low viscosity when ejected. The temperature of the ink lowers on the recording sheet to rapidly increase the viscosity of the ink. Therefore, the feathering and intercolor bleed can be suppressed. In the piezo ink-jet method, it is possible to eject a highly viscous liquid. Since the highly viscous liquid is unlikely to spread on the recording medium, the feathering and intercolor bleed can be suppressed.

In the ink-jet recording method and apparatus of the invention, the ratio of the mass of the ink per pixel to the mass of the second liquid per pixel is preferably 1:20 to 20:1, more preferably 1:10 to 10:1, still more preferably 1:5 to 5:1.

If the amount of the ink relative to the second liquid is excessively small or large, in some cases, the coagulation is insufficient, the optical density is decreased, and the feathering and intercolor bleed are worsened. The term “pixel” used herein refers to an area defined by the minimum distance separable in the main scanning direction at printing and the minimum distance separable in the sub scanning direction at printing. Appropriate ink sets are provided to each pixel, so that appropriate color and image density are obtained to form an image.

The ink and the second liquids are provided on the recording medium in such a manner that the two liquids contact with each other. When the two liquids contact with each other, the ink coagulates due to the function of the coagulant and printing properties such as the color rendition, uniformity in solid image areas, optical density, prevention of feathering, prevention of intercolor bleed, or drying time are improved. As long as the two liquids contact with each other, the manner of providing the liquids is not particularly limited. For example, the two liquids may be provided in such a manner that the two liquids on the recording medium are adjacent to each other or in such a manner that one of the liquids overlaps the other liquid on the recording medium.

With respect to the order of providing the respective liquids on the recording paper, it is preferable that the second liquid is provided first, then the ink is provided. When the second liquid is provided first, it is possible to effectively coagulate the inorganic oxide pigment. The ink may be provided at any time after the second liquid is provided. The second liquid is provided preferably within 0.5 seconds from the provision of the second liquid.

In the ink-jet recording method and apparatus of the invention, in each case of the ink and second liquid, the liquid mass per drop is preferably in a range of approximately 0.01 ng to 25 ng, more preferably in a range of approximately 0.5 ng to 20 ng, and still more preferably in a range of approximately 0.5 ng to 15 ng. If the liquid mass per drop is larger than approximately 25 ng, the feathering worsens in some cases. This is supposedly because the contact angle of the ink or second liquid with the recording medium changes according to the liquid amount per drop and the drop is more likely to spread on the surface of the sheet as the drop amount increases.

If the ink-jet recording apparatus can change the volume of the drop jetted from one nozzle, the “drop amount” refers to the minimum drop amount printable.

In the following, preferable embodiments of the ink-jet recording apparatus of the invention will be described in detail with reference to the figures. In the figures, members having practically the same function are represented by the same numeral, and overlapping explanations are omitted in the following description.

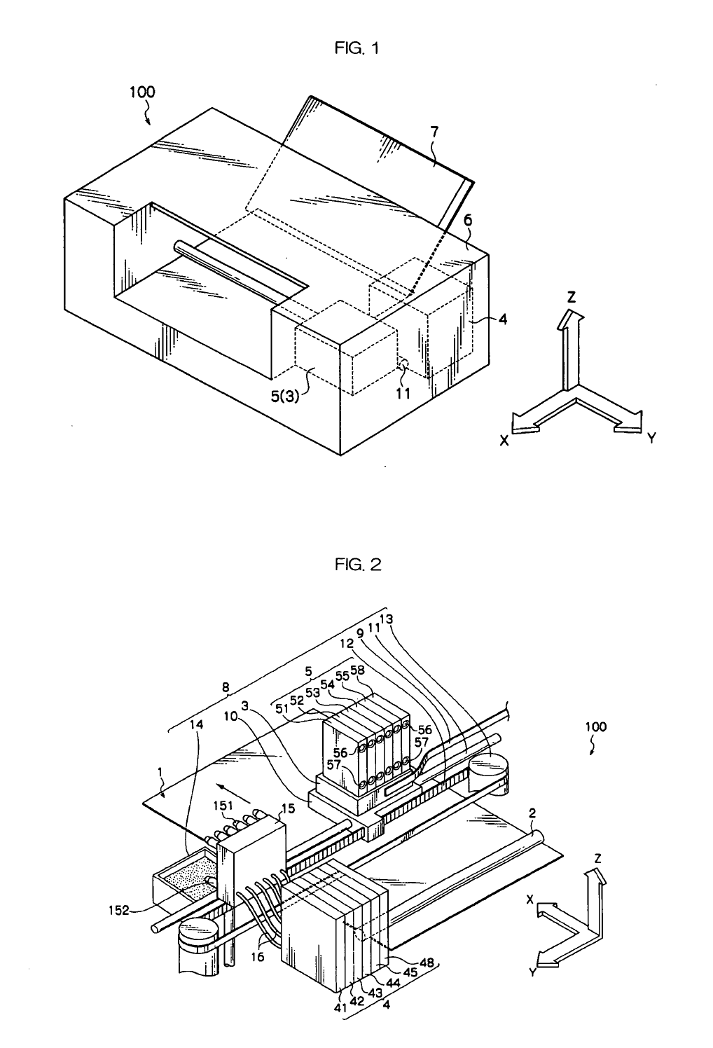

FIG. 1 is a perspective view illustrating the external constitution of a preferable embodiment of the ink-jet recording apparatus of the invention. FIG. 2 is a perspective view illustrating the basic interior constitution of the ink-jet recording apparatus (occasionally referred to as “image forming apparatus” hereinafter) of FIG. 1.

The image forming apparatus 100 of this embodiment forms an image by the ink-jet recording method of the invention. As shown in FIGS. 1 and 2, the image forming apparatus 100 comprises an outer cover 6, a tray 7, a conveyance roller 2, an image forming section 8, and a main tank 4. The tray 7 can bear a recording medium 1 upto a predetermined amount. The recording medium 1 may be a plain paper or the like. The conveyance roller 2 (conveying device) can convey the recording medium 1 sheet by sheet to the interior of the image forming apparatus 100. The image forming section 8 can eject the ink and a processing liquid onto the recording medium 1 to form an image. The main ink tank unit 4 can supply the ink and the processing liquid to their respective sub ink tank unit 5 in the image forming section 8 (image forming device).

The conveyance roller 2 is a device for conveying sheets. The device comprises a pair of rotatable rollers disposed in the image forming apparatus 100. The rollers pinch the recording medium 1 set on the tray 7 and convey a specified amount of the recording medium 1 sheet by sheet to the interior of the image forming apparatus 100 at a specified timing.

The image forming section 8 forms an ink image on the surface of the recording medium 1. The image forming section 8 comprises a recording head 3, a sub ink tank unit 5, a feeder signal cable 9, a carriage 10, a guide rod 11, a timing belt 12, a driving pulley 13, and a maintenance unit 14. The recording head 3 and the sub ink tank unit 5 are collectively represented by a sign “5(3)”.

The sub ink tank unit 5 has ink tanks 51, 52, 53, 54, 55 and 58. The sub ink tanks 51, 52, 53, 54, 55 and 58 each contain an ink in a different color or a processing liquid. The ink or processing liquid in the respective sub-tanks can be jetted from the recording head. For example, the sub ink tanks 51, 52, 53, 54, 55 and 58 may respectively contain a black ink (K), a yellow ink (Y), a magenta ink (M), a cyan ink (C), a white ink (W), and a processing liquid. In a case when the processing liquid is not used or in a case when the processing liquid contains a colorant, it is not necessary for the sub ink tank 5 to include a separate ink tank for the processing liquid. The ink in the ink set of the invention is used as the white ink (W), and the second liquid of the invention is used as the processing liquid in the ink jet recording apparatus of the invention.

Each of the sub ink tanks 51, 52, 53, 54, 55 and 58 in the sub ink tank unit 5 has an exhaust opening 56 and a replenishment opening 57. When the recording head 3 moves to a stand-by position (or a replenishment position), a exhaust pin 151 and a replenishment pin 152 are plugged respectively in the exhaust opening 56 and the replenishment opening 57, so that the sub ink tank unit 5 and a replenishment device 15 are connected. The replenishment device 15 is connected to the main ink tank unit 4 by replenishment tubes 16. The replenishment device 15 sends inks and the processing liquid from the main ink tank unit 4 to the sub ink tank unit 5 through the replenishment openings 57 so as to replenish the inks and the processing liquid in the sub ink tank unit 5.

The main tank unit 4 includes main ink tanks 41, 42, 43, 44, 45 and 48 each containing an ink in a different color or a processing liquid. For example, the main ink tanks 41, 42, 43, 44, 45 and 48 may contain respectively a black ink (K), a yellow ink (Y), a magenta ink (M), a cyan ink (C), a white ink (W), and a processing liquid. The processing liquid is the second liquid. Each of the main ink tanks is independently separable from the image forming apparatus 100.

As is shown in FIG. 2, the feeder signal cable 9 and the sub ink tank unit 5 are connected to the recording head 3. When an image recording information is transmitted from outside to the recording head 3 by the feeder signal cable 9, the recording head 3 suctions predetermined amounts of the inks and processing liquids from each of the sub ink tanks and ejects the inks and processing liquids to the surface of the recording medium 1, based on the image recording information. The feeder signal cable 9 supplies the recording head 3 with the power required for driving the recording head 3, in addition to transmitting the image recording information.

The recording head 3 is disposed on the carriage 10. The carriage 10 is connected to the timing belt 12, which is further connected to the guide rod 11 and the driving pulley 13. According to this structure, the recording head 3 can move along the guide rod 11 and can move in the direction Y (main scanning direction). The direction Y is parallel to the surface of the recording medium 1 and perpendicular to the direction X (sub scanning direction). The direction X is the direction of the transportation of the recording medium 1. A direction Z is an upward direction which is perpendicular to the directions X and Y.

The image forming apparatus 100 further comprises a control device (not shown) which controls the driving timing of the recording head 3 and the driving timing of the carriage 10 on the basis of the image recording information. The control device enables continuous image formation on a specified area on the recording medium 1, which is transported in the transportation direction X at a specified velocity, the image formation being conducted based on the image recording information.

The maintenance unit 14 is connected to a decompressor (not shown) by a tube. The maintenance unit 14 is further connected to the nozzle part of the recording head 3. The maintenance unit 14 suctions ink in the nozzles of the recording head 3 by having the condition of inside of each of the nozzles in a reduced pressure. The maintenance unit 14 can remove unnecessary ink in the nozzles during the operation of the image forming device 100 and can prevent the evaporation of the ink through the nozzles when the image forming device 100 is not operating.

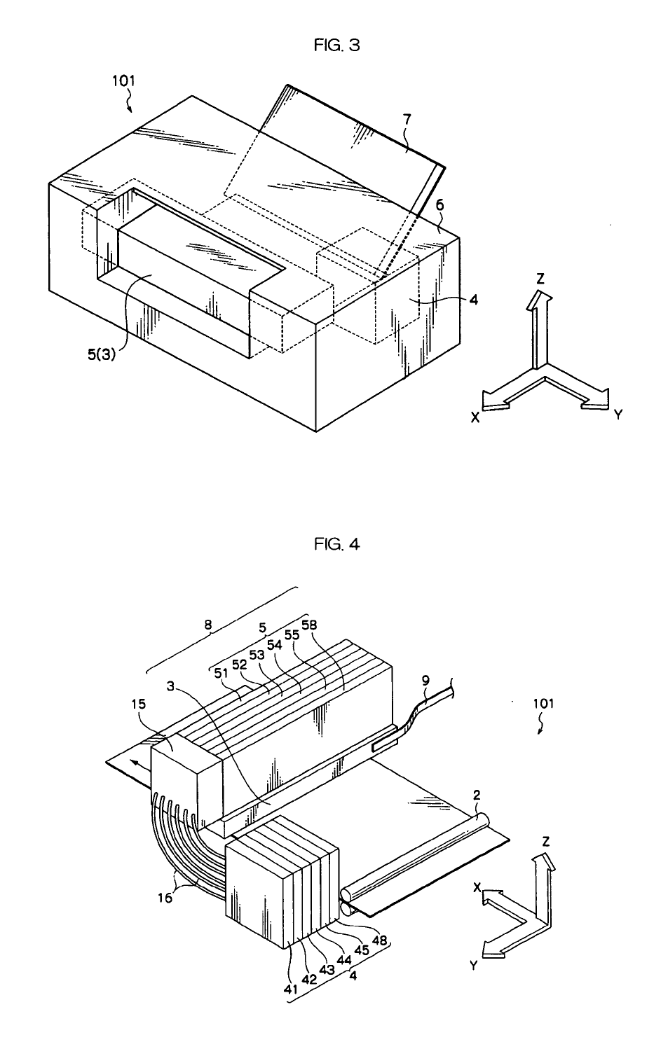

FIG. 3 is a perspective view illustrating the external constitution of another preferable embodiment of the ink-jet recording apparatus of the invention. FIG. 4 is a perspective view illustrating the basic interior constitution of the ink-jet recording apparatus (occasionally referred to as “image forming apparatus” hereinafter) of FIG. 3. The image forming apparatus 101 of this embodiment forms an image by the ink-jet recording method of the invention.

In the image forming apparatus 101 shown in FIGS. 3 and 4, the width of the recording head 3 is equal to or larger than the width of the recording medium 1. The image forming apparatus 101 does not have a carriage mechanism. The image forming apparatus 101 has a sheet conveyance system which conveys sheets in the sub scanning direction (the direction of the transportation of the recording medium 1, represented by the arrow X). While the sheet conveyance system is transportation rollers 2 in this embodiment, the system may be a belt-type sheet conveyance system.

The sub ink tanks 51 to 55 and 58 are arranged along the direction of the sub scanning direction X. Similarly, the nozzles (not shown) which eject inks of respective colors and the processing liquid are also arranged in the sub scanning direction. The other details of the constitution are the same as in the image forming apparatus 100 shown in FIGS. 1 and 2. In the FIGS. 3 and 4, the sub ink tank 5 has such a constitution that the sub ink tank 5 is always connected to the replenishment device 15 since the recording head 3 does not move. However, the sub ink tank unit 5 may be connected to the replenishment device 15 only at the replenishment of the ink or processing liquid.

The image forming apparatus 101 shown in FIGS. 3 and 4 conducts printing on the recording medium 1 in the direction (the main scanning direction) of the width of the recording medium 1 in a lump with the recording head 3. Therefore, the constitution of the apparatus is simpler than in the case of the apparatus having a carriage system, and the printing speed is also higher.

Further, a preferable aspect (second aspect) of the ink-jet recording method according to the invention includes utilizing of the ink-set according to the invention, discharging the ink from an ink-jet head to a recording medium, and coating the second liquid onto the recording medium by a roll so as to bring the ink into contact with the second liquid on the recording medium so as to form an image.

Furthermore, a preferable aspect (second aspect) of the ink-jet recording unit according to the invention includes utilizing of the ink-set according to the invention, and is provided with an ink-jet head that discharges the ink toward the recording medium and a roll that coats the second liquid on the recording medium.

In the second aspect of the ink-jet recording method and the second aspect of the unit according to the invention, preferable examples of the roll for coating the second liquid include a gravure roll, a dip roll, a transfer roll and a reverse roll.

In the second embodiment of the ink-jet recording method and apparatus of the invention, the ratio of the mass of the ink per pixel to be ejected to the mass of the second liquid per pixel to be coated is preferably 1:20 to 20:1, more preferably 1:10 to 10:1, still more preferably 1:5 to 5:1.

With respect to the order of ejecting and coating the respective liquids on the recording paper, it is preferable that the second liquid is coated first, then the ink is ejected. When the second liquid is coated first, it is possible to effectively coagulate the inorganic oxide pigment. The ink may be ejected at any time after the second liquid is coated. The second liquid is coated preferably within 0.5 seconds from the provision of the second liquid.

A white image may be either directly formed or formed on a portion where an image having colors other than white has been formed (overcoated) by the ink-jet recording method and the unit according to the invention with the ink-set according to the invention.

Clogging at an ink-jet head can be avoided in the ink-jet recording method and the unit according to the invention by the utilization of the ink-set according to the invention.

Further, a white image high in print density can be obtained when the white image is newly formed by the ink-jet recording method and the unit according to the invention.

Furthermore, a high masking property for an image other than white can be obtained when the white image is formed by the ink-jet recording method and the unit according to the invention over a portion where the image other than white has been formed.

The ink-set, the ink cartridge, the recording method and the recording unit according to the invention can be applied to form an image not only on permeable paper such as regular paper but also on a non-permeable medium such as art paper, film or metal. Accordingly, the ink-set, the ink cartridge, the recording method and the recording unit according to the invention can be applied to fields such as printed matter, technologies for preparing electric wiring boards, technologies for preparing display devices such as a color filter, liquid crystal display or organic electroluminescent (EL) display, medical film recordings, DNA information recordings and building materials such as wall paper or decoration plates.

The ink according to the invention is particularly suitable for an ink-jet recording method. Furthermore, the ink according to the invention can also be applied to offset printing, gravure printing, flexo printing screen printing and the like.

### EXAMPLES

In the following, the present invention will be explained more specifically with reference to examples. It should be noted that the examples should not be construed as limiting the invention. In the examples, the term “part” refers to “part by mass” unless specified otherwise.

In the following examples, the surface tension and the viscosity are measured according to the following methods.

### Surface Tension

The surface tension of the obtained ink is measured by use of a Wilhelmy surface tension meter (manufactured by Kyowa Interface Science Co., Ltd.) under an environment of 23±0.5° C. and 55±5% RH.

### Viscosity

The viscosity of the obtained ink is measured by using a viscometer (trade name: RHEOMAT 115, manufactured by Contraves) as a measurement unit. The measurement is conducted of ink that is contained in a measurement container and installed in a unit according to a predetermined method under conditions of a measurement temperature of 23° C. and a shearing speed of 1400 s⁻¹.

### Example 1

### Preparation of Pigment Dispersion

500 g of a slurry of titanium dioxide (rutile type, TiO₂ concentration: 80 mass percent; average primary particle diameter: 15 nm; surface-treated with a titanate coupler), 50 g of a resin obtained by adding sodium hydroxide to a styrene-acrylic acid-acrylic acid ester copolymer so as to neutralize the copolymer, and pure water are mixed, followed by dispersing with a sand mill, and further followed by filtering a coarse particle portion, and thereby a pigment dispersion (TiO₂ concentration: 25 mass percent; number average dispersion particle diameter: 45 nm; and titanium dioxide:resin ratio (mass ratio)=1:0.1) is obtained.

The composition used to prepare an ink for Example 1 is as follows.
Pigment dispersion (described above): 24 parts by mass
Diethylene glycol: 15 parts by mass
Glycerin: 20 parts by mass
Surfactant (trade name: SURFYNOL® 465, manufactured by Air Products and Chemicals, Inc.): 1.0 parts by mass

Pure water is added to the composition above, followed by blending, further followed by adjusting the pH to the proximity of 8.1, and filtering with a 5 μm filter, to obtain titanium dioxide dispersed ink having a number average dispersion particle diameter of 43 nm, η (viscosity) of 4.8 mPas and γ (surface tension) of 32 mN/m.

### Preparation of Second Liquid

Succinic acid: 10 parts by mass
Diethylene glycol: 15 parts by mass
SURFYNOL® 465 (described above): 0.5 parts by mass

Pure water is added to the composition above, followed by further adding an aqueous solution of alkali metal salt, and adjusting the pH to 4.5, to obtain a second liquid having η of 3.2 mPas and γ of 34 mN/m.

With the thus-obtained ink and second liquid, evaluations described below are carried out for Example 1.

### Comparative Example 1

With the ink obtained in the same manner as in Example 1, evaluations described below are carried out for Comparative example 1.

### Comparative Example 2

The composition used to prepare an ink for Comparative example 2 is as follows.
TiO₂ sol (peptized with nitric acid; pH: 1.5; primary particle diameter: 7 nm; TiO₂ concentration: 30 mass %): 20 parts by mass
Diethylene glycol: 28 parts by mass
Oxyethylene laurylether: 0.1 parts by mass

Pure water is added to the composition above, followed by adjusting the pH to the proximity of 1.8, to obtain an ink having a number average dispersion particle diameter of 15 nm, η (viscosity) of 3.6 mPas and γ (surface tension) of 42 mN/m.

### Preparation of Second Liquid

Manganese nitrate hexahydrate: 5 parts by mass
Diethylene glycol: 8 parts by mass
Glycerine: 17 parts by mass
SURFYNOL® 465 (described above): 0.5 parts by mass

Pure water is added to the composition above, and adjusting the pH to 7.0, to obtain a second liquid having η of 3.1 mPas and γ of 34 mN/m.

With the thus-obtained ink and second liquid, evaluations described below are carried out for Comparative example 2.

### Example 2

With the ink obtained in the same manner as in Example 1 and the second liquid obtained in the same manner as in Comparative example 2, evaluations described below are carried out for Example 2.

### Comparative Example 3

With the ink obtained in the same manner as in Comparative example 2 and the second liquid obtained in the same manner as in Example 1, evaluations described below are carried out for Comparative example 3.

### Example 3

The composition used to prepare an ink for Example 3 is as follows.

### Preparation of Ink

Pigment dispersion (described above): 24 parts by mass
Glycerin: 15 parts by mass
Polyethylene glycol (average molecular weight: approximately 200): 2 parts by mass
Oxyethylene oleyl ether: 0.2 parts by mass

Pure water is added to the composition above, followed by blending, further followed by adjusting the pH to the proximity of 8.3, and filtering with a 5 μm filter, to obtain titanium dioxide dispersed ink having a number average dispersion particle diameter of 41 nm, η (viscosity) of 3.6 mPas and γ (surface tension) of 38 mN/m.

With the thus-obtained ink and the second liquid prepared in the same manner as in Example 1, evaluations described below are carried out for Example 3.

### Comparative Example 4

With the ink obtained in the same manner as in Example 3, evaluations described below are carried out for Comparative example 4.

### Example 4

### Preparation of Pigment Dispersion

400 g of a slurry of titanium dioxide (rutile type, TiO₂ concentration: 75 mass percent; average primary particle diameter: 50 nm; surface-treated with a silicate coupler), 80 g of a resin obtained by adding lithium hydroxide to a methacrylic acid-methacrylic acid ester copolymer so as to neutralize the copolymer, and pure water are mixed, followed by dispersing with a ball mill, and further followed by filtering a coarse particle portion, and thereby a pigment dispersion (TiO₂ concentration: 20 mass percent; number average dispersion particle diameter: 85 nm; and titanium dioxide: resin ratio (mass ratio)=1:0.2) is obtained.

### Preparation of Ink

Pigment dispersion (described above): 30 parts by mass
Dipropylene glycol: 15 parts by mass
Glycerin: 25 parts by mass
1,2-hexanediol: 2 parts by mass
Glycerin: 25 parts by mass
Surfactant (trade name: OLFINE STG, manufactured by Nissin Chemical Industry Co., Ltd.): 1.2 parts by mass

Pure water is added to the composition above, followed by adjusting the pH to the proximity of 8.2, and filtering with a 5 μm filter, to obtain titanium dioxide dispersed ink having a number average dispersion particle diameter of 87 nm, η (viscosity) of 6.6 mPas and γ (surface tension) of 30 mN/m.

With the thus-obtained ink and the second liquid prepared in the same manner as in Example 1, evaluations described below are carried out for Example 4.

### Comparative Example 5

### Preparation of Pigment Dispersion

500 g of a slurry of titanium dioxide (rutile type, TiO₂ concentration: 95 mass percent; average primary particle diameter: 35 nm; surface-treated with a silicate coupler), 25 g of sorbitan stearate, and pure water are mixed, followed by dispersing with a sand mill, and further followed by filtering a coarse particle portion, and thereby a pigment dispersion (TiO₂ concentration: 30 mass percent; number average dispersion particle diameter: 85 nm) is obtained.

### Preparation of Ink

Pigment dispersion (described above): 15 parts by mass
Glycerine: 40 parts by mass
Tetraethylene glycol: 10 parts by mass
SURFYNOL® 465 (described above): 1.5 parts by mass

Pure water is added to the composition above, followed by blending, further followed by adjusting the pH to the proximity of 7.9, and filtering with a 5 μm filter, to obtain titanium dioxide dispersed ink having a number average dispersion particle diameter of 360 nm, η (viscosity) of 3 mPas and γ (surface tension) of 33 mN/m.

With the thus-obtained ink and the second liquid prepared in the same manner as in Example 1, evaluations described below are carried out for Comparative example 5.

### Example 5

### Preparation of Pigment Dispersion

500 g of a slurry of titanium dioxide (rutile type, TiO₂ concentration: 95 mass percent; average primary particle diameter: 25 nm; surface-treated with a titanate coupler), 2.5 g of a resin obtained by adding sodium hydroxide to a styrene-acrylic acid-acrylic acid ester copolymer so as to neutralize the copolymer, and pure water are mixed, followed by dispersing with a sand mill, and further followed by filtering a coarse particle portion, and thereby a pigment dispersion (TiO₂ concentration: 20 mass percent; number average dispersion particle diameter: 60 nm; and titanium dioxide:resin ratio (mass ratio)=1:0.005) is obtained.

### Preparation of Ink

Pigment dispersion (described above): 20 parts by mass
Triethylene glycol: 20 parts by mass
2-pyrrolidone: 10 parts by mass
Surfactant (trade name: OLFINE STG, manufactured by Nissin Chemical Industry Co., Ltd.): 1.2 parts by mass

Pure water is added to the composition above, followed by adjusting the pH to the proximity of 8.1, and filtering with a 5 μm filter, to obtain titanium dioxide dispersed ink having a number average dispersion particle diameter of 63 nm, η (viscosity) of 4.5 mPas and γ (surface tension) of 35 mN/m.

### Preparation of Second Liquid

Citric acid: 6 parts by mass
Glycerine: 10 parts by mass
SURFYNOL® 465 (described above): 0.7 parts by mass

Pure water is added to the composition above, followed by further adding an aqueous solution of alkali metal salt, and adjusting the pH to 4.2, to obtain a second liquid having η of 2.4 mPas and γ of 33 mN/m.

### Evaluation

On a character image (JEITA Standard Pattern J1 Chart) printed with a black pigment ink (trade name: INK for WORKCENTRE B900, manufactured by Fuji Xerox Co., Ltd.) on plain paper (trade name: C2 PAPER, manufactured by Fuji Xerox Co., Ltd.), the second liquid and one of the inks of Examples 1 through 5 and Comparative Examples 2, 3 and 5 are respectively discharged sequentially in this order so that a discharge amount of the second liquid is substantially one fourth a discharge amount of the ink, while a discharge amount per one drop of the ink is about 20 pl, to continually print at a print interval of about 0.2 s, or the ink alone is used to print a solid patch (2 cm×2 cm) on the black character image, by use of an experimentally produced ink-jet head (resolution: 600 dpi), so as to mask the character image portion, followed by carrying out evaluations (1) through (5) below. The results thereof are shown in Table 1.

### (1) Image Masking Degree

An image printed on a black character image is evaluated according to the following criteria.

A: A black character image portion is covered with white and cannot be read.

B: A black character image portion slightly shows through but cannot be completely read.

X: A black character image portion shows through and can be read.

### (2) Image Fixing Property

A printed portion is rubbed with fingers and evaluated according to the following criteria.

A: A non-image portion is not smeared.

B: A black character image therebelow cannot be read although the white image portion is slightly peeled off.

X: A white image portion is peeled off and a black character image therebelow can be read.

### (3) Drying Property

Solid patches are continuously printed and printed papers are superimposed. The time until a previously printed image is not transferred onto a back surface of a print is measured and this is evaluated according to criteria below.

A: Drying time is less than about 5 sec.

B: Drying time is about 5 sec or more and less than about 20 sec.

X: Drying time is about 20 sec or more.

### (4) Ink Dispersion Stability

Each of the inks prepared according to Examples 1 through 5 and Comparative Examples 1 through 5 is stored at about 60° C. for 1 week. Before and after the storage, number average dispersion particle diameters are measured and evaluated according to criteria below. Results thereof are shown in Table 1.

A: A difference obtained by subtracting a number average dispersion particle diameter before the storage from a number average dispersion particle diameter after the storage is less than about ±15% of the number average dispersion particle diameter before the storage.

B: A difference obtained by subtracting a number average dispersion particle diameter before the storage from a number average dispersion particle diameter after the storage is about ±15% or more and less than about ±30% of the number average dispersion particle diameter before the storage.

X: A difference obtained by subtracting a number average dispersion particle diameter before the storage from a number average dispersion particle diameter after the storage is about ±30% or more of the number average dispersion particle diameter before the storage.

### (5) Head Clogging Property

With each of the ink-sets according to Examples 1 through 5 and Comparative Examples 2, 3 and 5 and the inks according to Comparative Examples 1 and 4, printing is carried out under the above conditions, and the respective ink-sets/inks are left to stand at about 23° C. for one week with a cap fastened. Without applying maintenance after being left to stand, a ratio of dischargeable nozzles is measured. Results thereof are shown in Table 1.

A: A ratio of dischargeable nozzles after the storage is about 90% or more.

B: A ratio of dischargeable nozzles after the storage is about 70% or more and less than about 90%.

X: A ratio of dischargeable nozzles after the storage is less than about 70%.

Furthermore, with each of the ink-sets according to Examples 1 through 5 and Comparative Examples 2, 3 and 5, a second liquid is coated over an entire print surface with a roll (gravure roll) on a print where a character image is printed with a black pigment ink, so as to mask the character image portion, followed by discharging the ink after two seconds on a coated portion with an ink-jet head (resolution: 600 dpi) to print a solid patch (2 cm×2 cm) on the black character image, further followed by applying the above evaluations (1) through (3). The results are shown in Table 1.

TABLE 1

| | Ink jet head is used for discharging ink singly | | | | | Roller is used for | | |
|---|---|---|---|---|---|---|---|---|
| | or both of ink and second liquid | | | | | coating second liquid | | |
| | Image | Image | | Ink | Head | Image | Image | |
| | Masking | Fixing | Drying | Dispersion | Clogging | Masking | Fixing | Drying |
| | Degree | Property | Property | Stability | Property | Degree | Property | Property |
| Example 1 | A | A | A | A | A | A | A | A |
| Comparative | X | A | A | A | A | — | — | — |
| example 1 | | | | | | | | |
| Comparative | partially X | X | X | A | A | partially X | X | X |
| example 2 | | | | | | | | |
| Example 2 | B | A | A | A | A | B | A | A |
| Comparative | partially X | X | X | A | A | partially X | X | X |
| example 3 | | | | | | | | |
| Example 3 | A | A | B | A | A | A | A | B |
| Comparative | partially X | A | X | A | A | — | — | — |
| example 4 | | | | | | | | |
| Example 4 | A | A | A | A | A | A | A | A |
| Comparative | A | X | A | B | X | A | X | A |
| example 5 | | | | | | | | |
| Example 5 | B | B | A | A | A | B | B | A |

As is understood from the results shown in Table 1, Examples 1 through 5 achieve superior effects in all aspects of image masking degree, image fixing property, drying property, ink dispersion stability, and head clogging property.

### Example 6

### Preparation of Pigment Dispersion

400 g of a slurry of titanium dioxide (rutile type, TiO₂ concentration: 92 mass percent; average primary particle diameter: 35 nm; surface-treated with a silicate coupler), 40 g of a resin obtained by adding sodium hydroxide to a styrene-methacrylic acid-methacrylic acid ester copolymer so as to neutralize the copolymer, and pure water are mixed, followed by dispersing with a nanomizer, and further followed by filtering a coarse particle portion, and thereby a pigment dispersion (TiO₂ concentration: 15 mass percent; number average dispersion particle diameter: 54 nm; and titanium dioxide:resin ratio (mass ratio)=1:0.1) is obtained.

### Preparation of Ink

Pigment dispersion (described above): 40 parts by mass
Diethylene glycol: 15 parts by mass s
Diglycerine oxyethylene adduct: 10 parts by mass
Acetylene diol oxyethylene adduct (trade name: OLFINE E1004, manufactured by Nissin Chemical Industry Co., Ltd.): 0.5 parts by mass
Acetylene diol oxyethylene adduct (trade name: OLFINE E1010, manufactured by Nissin Chemical Industry Co., Ltd.): 1 parts by mass

Pure water is added to the composition above, followed by blending, further followed by adjusting the pH to the proximity of 8.1, and filtering with a 5 μm filter, to obtain titanium dioxide dispersed ink having a number average dispersion particle diameter of 76 nm, η (viscosity) of 3.8 mPas and γ (surface tension) of 29 mN/m.

### Preparation of Second Liquid

Salicylic acid: 5 parts by mass
Glycerine: 20 parts by mass
SURFYNOL® 465 (described above): 0.5 parts by mass

Pure water is added to the composition above, and adjusting the pH to 4.0, to obtain a second liquid having η of 2.6 mPas and γ of 32 mN/m.

On a paper (trade name: RECYCLE COLOR PAPER 100, manufactured by Fuji Xerox Co., Ltd.), the second liquid and the ink of Example 6 are respectively discharged sequentially in this order so that a discharge amount of the second liquid is substantially one fifth a discharge amount of the ink, while a discharge amount per one drop of the ink is about 25 pl, to continually print at a print interval of about 0.5 s to print a white solid patch (5 cm×5 cm), by use of an experimentally produced ink-jet head (resolution: 600 dpi), followed by carrying out evaluations of (2) image fixing property, (3) drying property, and the following (6) whiteness degree.

### (6) Whiteness Degree

In accordance with a known whiteness degree measurement method (method for measurement of diffuse blue reflectance factor (ISO brightness)), the whiteness degree of each printed solid patche is measured and evaluated according to the criteria below.

A: Whiteness degree is about 80% or more.

B: Whiteness degree is about 60% or more and less than about 80%.

X: Whiteness degree is less than about 60%.

The Results are shown in Table 2.

TABLE 2

| | Image fixing property | Drying property | Whiteness degree |
|---|---|---|---|
| Example 6 | A | A | A |

### Example 7

### Preparation of Pigment Dispersion

500 g of a slurry of titanium dioxide (rutile type, TiO₂ concentration: 96 mass percent; average primary particle diameter: 35 nm), 50 g of a resin obtained by adding sodium hydroxide to a methacrylic acid-methacrylic acid ester copolymer so as to neutralize the copolymer, and pure water are mixed, followed by dispersing with a ball mill, and further followed by filtering a coarse particle portion, and thereby a pigment dispersion (TiO₂ concentration: 20 mass percent; number average dispersion particle diameter: 220 nm; and titanium dioxide:resin ratio (mass ratio)=1:0.1) is obtained.

### Preparation of Ink

Pigment dispersion (described above): 25 parts by mass
Glycerin: 16 parts by mass
Dipropylene glycol: 7 parts by mass
1,2-hexanediol: 4 parts by mass
Diethylene glycol monobutyl ether: 6 parts by mass

Pure water is added to the composition above, followed by adjusting the pH to the proximity of 8.4, and filtering with a 5 μm filter, to obtain titanium dioxide dispersed ink having a number average dispersion particle diameter of 210 nm, η (viscosity) of 3.9 mPas and γ (surface tension) of 36 mN/m.

### Preparation of Second Liquid

Pyrrolidone carboxylic acid: 8 parts by mass
Triethylene glycol: 10 parts by mass
Glycerine: 10 parts by mass
Oxyethylene-2-ethylhexyl ether: 0.8 parts by mass

Pure water is added to the composition above, followed by further adding an aqueous solution of alkali metal salt, and adjusting the pH to 4.3, to obtain a second liquid having η of 2.8 mPas and γ of 34 mN/m.

With the thus-obtained ink and the second liquid, the evaluations of (1) to (5) are carried out for Example 7.

### Example 8

### Preparation of Pigment Dispersion

300 g of a slurry of zinc oxide (rutile type, ZnO concentration: 90 mass percent; average primary particle diameter: 75 nm), 10 g of a resin obtained by adding sodium hydroxide to an acrylic acid-acrylic acid ester copolymer so as to neutralize the copolymer, and pure water are mixed, followed by dispersing with a microfluidizer, and further followed by filtering a coarse particle portion, and thereby a pigment dispersion (ZnO concentration: 10 mass percent; number average dispersion particle diameter: 87 nm; and zinc oxide:resin ratio (mass ratio)=1:0.033) is obtained.

### Preparation of Ink

Pigment dispersion (described above): 40 parts by mass
Diethylene glycol: 22 parts by mass
Propylene glycol: 10 parts by mass
1,3-butanediol: 5 parts by mass
Oxyethylene oxypropylene block polymer: 1.5 parts by mass

Pure water is added to the composition above, followed by adjusting the pH to the proximity of 7.9, and filtering with a 5 μm filter, to obtain zinc oxide dispersed ink having a number average dispersion particle diameter of 92 nm, η (viscosity) of 4.4 mPas and γ (surface tension) of 34 mN/m.

### Preparation of Second Liquid

Phthalic acid: 7 parts by mass
Ethylene glycol: 5 parts by mass
Diglycerine: 15 parts by mass
Oxyethylene oleyl ether: 1.0 parts by mass

Pure water is added to the composition above, followed by further adding an aqueous solution of alkali metal salt, and adjusting the pH to 3.7, to obtain a second liquid having η of 3.1 mPas and γ of 37 mN/m.

With the thus-obtained ink and the second liquid, the evaluations of (1) to (5) are carried out for Example 7.

The results of the evaluations for Examples 7 and 8 are shown in Table 3.

| | Image | Image | | Ink | Head |
|---|---|---|---|---|---|
| | Masking | Fixing | Drying | Dispersion | Clogging |
| | Degree | Property | Property | Stability | Property |
| Example 7 | A | A | A | B | B |
| Example 8 | B | A | A | A | A |

What is claimed is:

1. An ink-jet ink set comprising:
an ink that comprises an inorganic oxide pigment and a resin; and
a second liquid that comprises a coagulant capable of coagulating the inorganic oxide pigment.

2. The ink-jet ink set of claim 1, which is capable of recording a white image.

3. The ink-jet ink set of claim 1, wherein a number average dispersed-particle diameter is in a range of approximately 10 to 100 nm.

4. The ink-jet ink set of claim 1, wherein the inorganic oxide pigment comprises at least one of titanium dioxide and zinc oxide.

5. The ink-jet ink set of claim 1, wherein the inorganic oxide pigment comprises titanium dioxide.

6. The ink-jet ink set of claim 1, wherein the resin comprises a weak acid group or a weak base group.

7. The ink-jet ink set of claim 1, wherein the resin comprises a weak acid group.

8. The ink-jet ink set of claim 1, wherein the coagulant is selected from the group consisting of an organic acid, a salt of an organic acid, an inorganic metallic salt, and an organic polyamine compound.

9. The ink-jet ink set of claim 1, wherein the coagulant is selected from the group consisting of an organic acid and a salt of an organic acid.

10. The ink-jet ink set of claim 1, wherein a mass ratio of an amount of the inorganic oxide pigment to an amount of the resin (inorganic oxide pigment:resin) is in a range of approximately 1:0.01 to 1:0.3.

11. An ink cartridge comprising an ink-jet ink set that comprises:
an ink that comprises an inorganic oxide pigment and a resin; and
a second liquid that comprises a coagulant capable of coagulating the inorganic oxide pigment.

12. An ink-jet recording method comprising:
providing an ink-jet ink set comprising:
an ink that comprises an inorganic oxide pigment and a resin; and
a second liquid that comprises a coagulant capable of coagulating the inorganic oxide pigment; and
forming an image on a recording medium by:
ejecting, from an ink-jet recording head, the ink onto the recording medium; and
applying the second liquid onto the recording medium.

13. The ink-jet recording method of claim 12, wherein the image is a white image.

14. The ink-jet recording method of claim 12, wherein the applying of the second liquid is conducted by ejecting the second liquid from the ink-jet recording head, and the ejecting of the second liquid is followed by the ejecting of the ink.

15. The ink-jet recording method of claim 12, wherein the applying of the second liquid is conducted by coating using a roller.

16. The ink-jet recording method of claim 15, wherein the coating of the second liquid is followed by the ejecting of the ink.

17. An ink-jet recording apparatus that uses an ink-jet ink set comprising an ink that comprises an inorganic oxide pigment and a resin and a second liquid that comprises a coagulant capable of coagulating the inorganic oxide pigment, comprising:
an ink-jet recording head that ejects the ink onto a recording medium; and
a device that applies the second liquid onto the recording medium.

18. The ink-jet recording apparatus of claim 17, which is capable of recording a white image.

19. The ink-jet recording apparatus of claim 17, wherein the device that applies the second liquid is the ink-jet recording head, which ejects the second liquid onto the recording medium.

20. The ink-jet recording apparatus of claim 17, wherein the device that applies the second liquid is a roller that coats the second liquid onto the recording medium.
